(19) United States
(12) Patent Application Publication
(10) Pub. No.: US 2026/0225304 A1
(43) Pub. Date: Aug. 6, 2026

(54) FORMING TABLE

(71) Applicant: Tusas- Turk Havacilik Ve Uzay Sanayii Anonim Sirketi, Kahramankazan, Ankara (TR)

(72) Inventors: Cagri AKIN, Kahramankazan, Ankara (TR); Turker DOLEK, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/149,906

(22) PCT Filed: Jan. 19, 2024
(86) PCT No.: PCT/TR2024/050042

§ 371 Date: Jul. 22, 2025

(30) Foreign Application Priority Data
Jan. 23, 2023 (TR) 2023/000765

(51) Int. Cl. B29C 53/04; B29K 101/12; B29K 105/00

(52) U.S. Cl. CPC B29C 53/04; B29K 2101/12; B29K 2105/256

(57) ABSTRACT

A forming table (1) comprising a body, a mandrel (3) on the body that gives form to the material (M) to be shaped, and a frame for holding the material (M) comprising at least two arms (401) located on the body, each arm having two bending elements (4001) located thereon. Opposing bending elements (4001) are connected via a hinge (5), the table further having a force applying means (6) for applying force to each bending element. The force applying means is configured to apply force to the bending elements so as to bend both edges of the material (M) simultaneously. Preferably, the force applying means is attached to a device (9) slidably positionable by a user on the bending elements (4001). Preferably, the forming table (1) is arranged to bend a transparent thermoplastic sheet (M) to shape it into an aircraft canopy.

This invention relates to an aircraft canopy forming table.

The canopy is a transparent structure that increases the pilot's visibility by wrapping the cockpit in some types of aircraft. First of all, it is aimed to separate the pilot and the external environment and to protect the pilots against the dangers that may occur. In addition, the canopy is a structure that affects the aerodynamics of the aircraft. It is used in aerobatic and fighter aircraft as it reduces friction while isolating noise and meteorological effects. Materials such as acrylic and polycarbonate used in the manufacture of canopy glass are usually formed by vacuum. However, since the material thickness is changed uncontrollably in vacuum shaping processes, the light refractions occurring in the glass are not at an acceptable level, especially in fighter aircraft.

The German patent document EP0882566, which is included in the known state of the art, describes an adjustable clamping frame for a forming station of a thermoforming machine, wherein thermoplastic-made heated plates are deformed by means of a mold via differential pressure according to their type. There is a closed box in which are placed a stationary clamping frame that clamps the plate as well as a height-adjustable upper frame, wherein the forming station can be continuously adjusted by inserting molded parts of different sizes.

The U.S. Pat. No. 5,026,514, which is included in the known state of the art, describes a conveyor system for the heating and subsequent forming processes of a laminate to be formed.

Thanks to a forming table developed by the present invention, a canopy is produced by bending a material to a desired extent by means of bending elements connected to a single weight.

Another object of the invention is to make weight application points and the bending axis adjustable.

Another object of this invention is to apply a force to the material just to give it a shape without applying a stretching process, so that the thickness of the canopy can be controlled depending on the requirements.

The forming table realized to achieve the object of the invention, defined in the first claim and in the claims dependent on that claim, comprises a body into which a material made of an acrylic thermoplastic material with a transparent structure is placed. The body is provided with a mandrel thereon, on which the material is to be formed. There is a frame that enables to keep the material on the body.

The forming table of the invention comprises at least two arms that mutually hold the material on the body and constitute the frame. The arms consist of at least two bending elements enabling the material to be shaped on the mandrel. There is at least one rotary element that connects the arm to the body in order for the bending elements located on the same arm to bend the material. A trigger applies force to each bending element, making the arm rotate around the rotary element, enabling the material to be placed on the mandrel. At least one part is produced by subjecting the material placed on the mandrel to heat treatment.

In an embodiment of the invention, the forming table comprises an axis extending throughout longitudinally on the mandrel. The bending elements and arms are located so as to be mirror symmetrical with respect to the axis on which the mandrel extends.

In an embodiment of the invention, the forming table comprises a trigger applied to the bending elements as the weight. Thus, it enables one of the bending elements to be bent clockwise and the other one counterclockwise under the effect of gravity.

In an embodiment of the invention, the forming table comprises multiple pulleys in the form of stationary pulleys, changing the direction of the force applied to the bending elements by making a rotational movement around its own axis. There is at least one elastic member in the form of a rope wrapped around a pulley, one end thereof being at the bending elements, one end thereof being subjected to an applied force, thereby enabling the force to be transmitted to the bending elements by means of the pulley. The pulley enables the bending elements to place the material on the mandrel by connecting the trigger to the elastic element.

In an embodiment of the invention, the forming table comprises apparatuses located at user-desired positions so as to be mirror symmetrical with respect to the throughout longitudinal axis of the mandrel on the bending elements.

In an embodiment of the invention, the forming table comprises at least two holes, one of which forming an opening on the apparatus and the other one a mutual opening on the bending element. Pins are inserted into mutually located holes. Thus, the apparatuses are fixed on the bending elements at user-desired positions.

In an embodiment of the invention, the forming table comprises a base on which the body is placed. On the surface of the bending elements that faces the base are provided multiple grooves forming a recess. There is at least one protrusion that is form-fitting with the grooves and extends outwardly over the apparatuses, thus limiting the horizontal movement of the apparatuses on the bending element.

In an embodiment of the invention, the forming table is mirror-symmetrical with respect to an axis and comprises bending elements there between located at a manufacturer-determined distance. There is at least one support arm located between each bending element and the base. First pulleys are located between the support arms and are mirror-symmetrical with respect to the axis. Second rollers are located on the support elements. Connecting the trigger to the elastic element which is passed by the user around the first pulleys and the second pulleys, it is enabled to bend the bending elements.

In an embodiment of the invention, the forming table comprises support elements located between the material and the mandrel, so as to be mirror-symmetrical with respect to the axis. Thus, the support elements ensure that the material is supported while the material takes the shape of the mandrel.

In an embodiment of the invention, the forming table comprises at least one channel that creates a throughout longitudinal gap on the bending elements. Support elements are connected to the apparatuses and can move within the channel, such that the distances between them can be adjusted by the user.

In an embodiment of the invention, the forming table comprises at least one hanger that protrudes out of the apparatuses. One end of the elastic element is located on the hanger and the other end thereof is located on the second rollers, such that the elastic element is moved when the user moves the apparatuses.

In an embodiment of the invention, the forming table comprises at least one holder located between the arms, forming the frame and holding the material. The holder can be moved horizontally in the channel by the user so as to enable the material to expand.

In an embodiment of the invention, the forming table comprises a first position (I) in which the arms are positioned parallel to the base. It comprises a second position (II) in which the arms are brought closer to the base and the material takes almost the form of the mandrel. There is at least one rod on the body which the holder and the edge of the part contacts when the arms are brought from the first position (I) to the second position (II), thereby almost taking the shape of the holder and enabling it to be fixed.

In an embodiment of the invention, the forming table comprises a part that is a canopy used in aircraft.

The forming table realized to achieve the object of the present invention is shown in the attached figures, wherein from these figures;

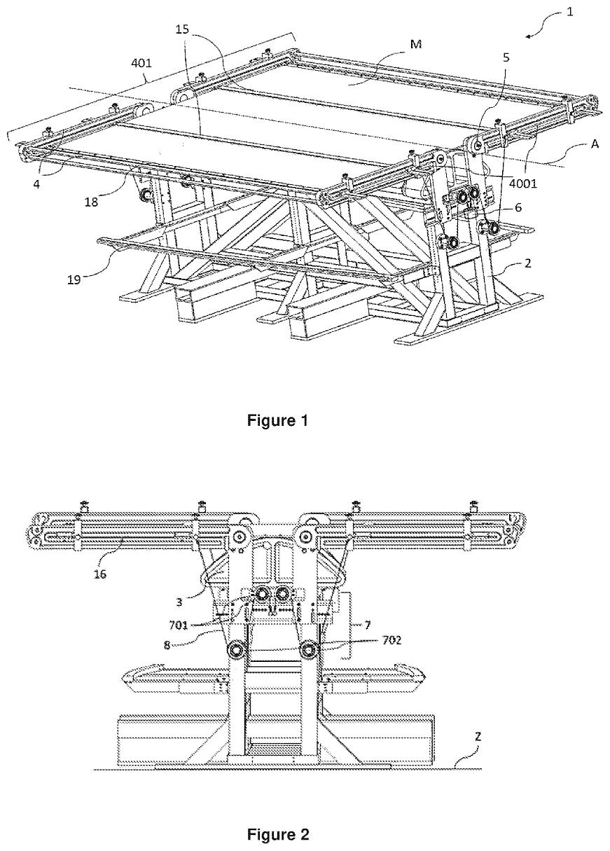

FIG. 1 is a perspective view of the body and base.

FIG. 2 is a front view of the arms when they are in the first position (I).

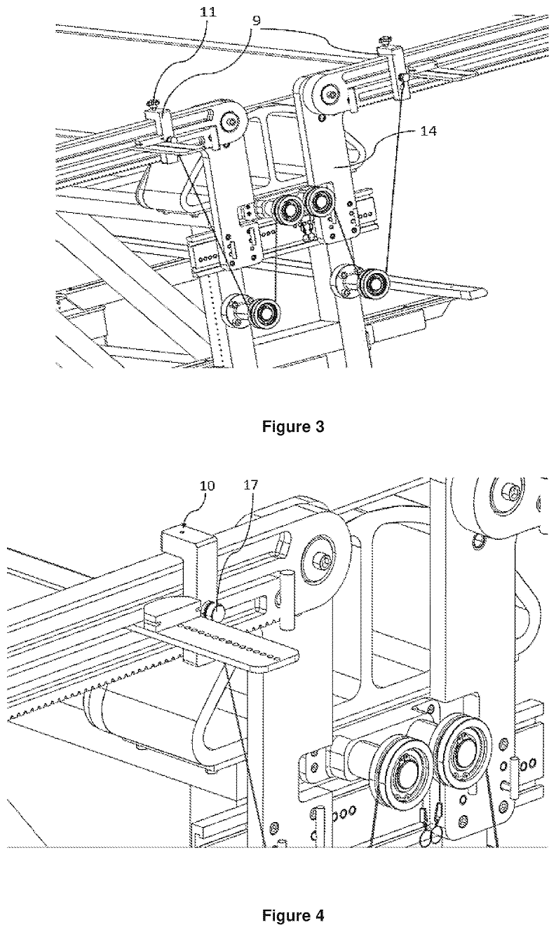

FIG. 3 is a perspective view of the apparatus, pin, and support arm.

FIG. 4 is a perspective view of the hole and hanger.

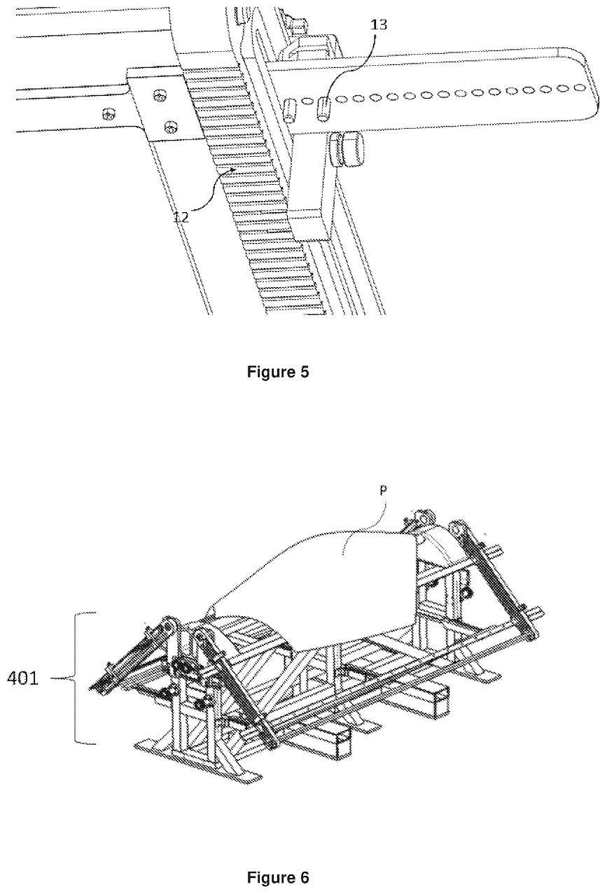

FIG. 5 is a perspective view of the groove and projection.

FIG. 6 is a perspective view of the arms when they are in the second position (II).

The parts illustrated in figures are individually assigned a reference numeral and the corresponding terms of these numerals are listed below.
1. Forming table
2. Body
3. Mandrel
4. Frame
   401. Arm
   4001. Bending element
5. Rotary element
6. Trigger
7. Pulley
   701. First pulley
   702. Second pulley
8. Elastic element
9. Apparatus
10. Hole
11. Pin
12. Groove
13. Protrusion
14. Support arm
15. Support element
16. Channel
17. Hanger
18. Holder
19. Bar
(M) Material
(A) Axis
(P) Part
(Z) Base

The forming table (1) comprises a body (2), at least one material (M) made of a thermoplastic material, placed on the body (2) to be subjected to a forming process and transformed from a regular structure into a glassy structure by means of heat, at least one mandrel (3) on the body (2) to give shape to the material (M), and at least one frame (4) enabling the material (M) to be attached onto the body (2).

The forming machine (1) according to the invention comprises at least two arms (401) located on the frame (4) and enabling the material (M) to be held at least partially mutually, at least two bending elements (4001) located on the arms (401) and enabling the material (M) to be shaped on the mandrel (3), at least one rotary element (5) to which both bending elements (4001) are connected and enabling the bending elements (4001) to rotate there around, at least one trigger (6) applying force to each bending element (4001), thereby enabling them to rotate around the rotary element (5) so that the material (M) is placed on the mandrel (3) by bending both of its edges simultaneously, and at least one part (P) formed by heat treating the material (M).

The transparent acrylic thermoplastic material (M) to be used in the manufacture of the canopy is placed on the body (2). The mandrel (3) is located on the body (2), enabling the material (M) to be brought into the canopy form. The mandrel (3) is selected by the user according to the form to be given to the material (M). The material (M) is held on the body (2) by a frame (4) surrounding the periphery of the material (M). (FIG. 2, FIG. 3)

The material (M) is held by two mutually located arms (401) that form the frame (4). There are two bending elements (4001), which are provided correspondingly in both of the mutually-located arms (401) and enable the material (M) to be bent from its edges and placed onto the mandrel (3). The rotary element (5), which is a joint, enables the bending elements (4001) to rotate around the place where they are connected to the arm (401). A downward force is applied to each bending element (4001) by means of the trigger (6). The downwardly drawn bending elements (4001) bend the parts of the material (M) to which they are connected downwards. Thus, the material (M) is placed onto the mandrel (3) without being subjected to a stretching process. By means of this, time is saved in the process of forming the transparent acrylic thermoplastic material (M). It is ensured that it becomes a part (P) by applying heat treatment to the material. (FIG. 1)

In an embodiment of the invention, the forming table (1) comprises an axis (A) throughout which the mandrel (3) extends longitudinally, wherein the bending elements (4001) are located mirror-symmetrically with respect to the axis (A). With the bending elements (4001) being located mirror-symmetrically with respect to the axis (A), the material (M) is placed evenly on both sides of the mandrel (3).

In an embodiment of the invention, the trigger (6) comprised by the forming table (1) is a weight, thereby applying a gravitational force to the bending elements (4001), enabling one to make a clockwise rotational movement and the other one a counterclockwise rotational movement on the rotary element (5). By applying only one weight to both bending elements (4001) located on the same arm (401), it is ensured that the bending elements (4001) are brought closer onto the mandrel (3) on two mutually located edges of the material (M). (FIG. 1) In an embodiment of the invention, the forming table (1) comprises multiple pulleys (7) being located on the body (2) in a stationary manner, thereby changing the direction of the force by making a rotational movement around their own axes, at least one elastic element (8), one end thereof being located on the bending elements (4001), the other end thereof being subjected to an applied force, passing over the pulleys (7) and enabling the force applied to the end thereof to be transferred to the bending elements (4001) by means of the pulleys (7), the pulleys (7) enabling the bending elements (4001) to rotate on the rotary element (5) by connecting the trigger (6) to the elastic element (8). The force is applied to the bending elements (4001) with the help of a stationary pulley (7) system. The bending elements (4001) are bent by a weight attached by the user to the end of the pulley (7) system. (FIG. 2)

In an embodiment of the invention, the forming table (1) comprises at least two apparatuses (9) being located on the bending elements (4001) so as to be mirror-symmetrical with respect to the axis (A), said apparatuses being placed and fixed to a desired position on the bending elements (4001) by the user and the elastic element (8) being connected thereto, thereby enabling the moment on the rotary element (5) to be changed. There are apparatuses (9) provided on each of the bending elements (4001). Thanks to the fact that these apparatuses (9) are located mirror-symmetrically with respect to the axis (A), each bending element (4001) is bended simultaneously.

In an embodiment of the invention, the forming table (1) comprises at least two holes (10), one thereof being located on the apparatuses (9) and the other one on the bending elements (4001) so as to form mutual openings, and at least two pins (11), being inserted by a user into the mutual holes (10), thus enabling the apparatuses (9) to be fixed at user-desired positions on the bending elements (4001). The position of the apparatuses (9) on the bending elements (4001) can be adjusted by the user. Thus, the weight application point can be controlled by the user. The adjustment of the position of the apparatuses (9) is provided by means of mutually located holes (10) on the apparatuses (9) and the bending elements (4001). The user can fix the position of the apparatus (9) by means of the pin (11) at any point where there are mutual holes (10). (FIG. 3)

In an embodiment of the invention, the forming table (1) comprises a base (Z) on which the body (2) is located, multiple grooves (12) forming recess on the surface of the bending elements (4001) that is close to the base (Z), and at least one protrusion (13) extending outwardly over the apparatuses (9) and being provided in a form-fitting manner to the grooves (12), thereby preventing the horizontal movement of the apparatuses (9) on the bending elements (4001). The lower surface of the bending elements (4001) consists of grooves (12), these grooves (12) enabling to limit the lateral movement of the apparatus (9). The projections (13) on the apparatus (9) are placed into the grooves (12). (FIG. 5)

In an embodiment of the invention, the bending elements (4001) comprised by the forming table (1) are mirror-symmetrical with respect to the axis (A) and have a distance in between them which is manufacturer-determined, at least one support arm (14) extends from the end of each bending element (4001) that is close to the axis (A) towards the base (Z), at least two first pulleys (701) are located between the support arms (14) and on the body (2) so as to be mirror-symmetrical with respect to the axis (A), at least two second pulleys (702) are located on the support arms (14), the trigger (6) enabling the bending elements (4001) to rotate on the rotary element (5) by being connected to the end of the elastic element (8) passing over the first pulleys (701) and the second pulleys (702). Two of the pulleys (7) are located on the support arms (14) between the bending elements (4001) and the base (Z). The other two pulleys (7) are located between the support arms (14). A single weight is attached to the end of the elastic element (8) that is passed over these pulleys (7). Thus, both bending elements (4001) are bent by means of a single weight. (FIG. 4)

In an embodiment of the invention, at least two support elements (15) comprised by the forming table (1) are located between the mandrel (4) and the material (M) so as to be mirror-symmetrical with respect to the axis (A), thereby supporting the material (M) as it is given shape during the forming process. There are two support elements (15) provided underneath the material (M) so as to contact it and being mirror-symmetrical with respect to the axis (A). Thus, they provide support equally to both sides during the forming process of the material (M) on the mandrel (3).

In an embodiment of the invention, the forming table (1) comprises at least one channel (16) forming a throughout longitudinal opening on the bending elements (4001), the support elements (15) being located in connection with the apparatuses (9) so as to be movable along the channel (16), thereby making the distance between the apparatuses adjustable. By means of the channel (16) that is provided on the bending elements (4001), the position of the apparatuses (9) can be displaced, and therefore the application point of the weight and the application site of the bending can be changed.

In an embodiment of the invention, the forming table (1) comprises at least one hanger (17) extending outwardly over the apparatuses (9), the elastic element (8) being able to move together with the support elements (15) with one end of the elastic element being located on the hanger (17) and the other end thereof on the second pulley (702). One end of the elastic element (8) passing over the pulleys (7) is located on the hanger (17), thereby pulling the hanger (17) downwards with the effect of weight applied from the other end of the elastic element (8), thus enabling the downward movement of the bending elements (4001).

In an embodiment of the invention, the forming table (1) comprises at least one holder (18) forming the frame (4), being located between the arms (401) and ensuring the continuity of the form of the material by holding the material (M) along at least one edge thereof, the position of the channel (16) between the arms (401) being adjustable by the user according to the size of the material (3) by sliding the channel on the holder. The holders (18) can move laterally in the channel (16), thus enabling the edges of the material (M) coupled to the holder (18) to move away from each other.

In an embodiment of the invention, the forming table (1) comprises a first position (I) in which the arms (401) are located parallel to the base (Z), a second position (II) to which the arms (401) are brought by being bent and take almost the shape of the mandrel (3), and at least one rod (19) being located on the body (2), contacting the holder (18) when the arms (401) are bent and brought from the first position (I) to the second position (II), and taking almost the shape of the holder (18) that gives the edge shape to the part (P) and enabling it to be fixed The material (M) is first placed parallel to the base (Z). By bending the bending elements (4001), the holder (18) is brought into contact with the rod (19). The holder (18), which is flexible like a spring steel, takes the shape of the rod (19). Thus, the canopy form to be created is obtained by the material (M) taking the shape of the mandrel (3) and the rod (19). The material (M) bending elements (4001) are placed into a furnace in the first position (I). In this way, the material (M) passing into the glassy structure is cooled when it is in the second position (II).

In an embodiment of the invention, the forming table (1) comprises a part (P) that is a canopy. The production of the canopy is carried out in a short time by controlling any light refractions by virtue of the controlled change in the thickness of the material (M).

1. A forming table (1) comprising a body (2), at least one material (M) made of a thermoplastic material, that is placed on the body (2) to be subjected to a forming process and transformed from a regular structure into a glassy structure by means of heat, at least one mandrel (3) that is located on the body (2) to give shape to the material (M), at least one frame (4) that enables the material (M) to be attached onto the body (2), at least two arms (401) that are located on the frame (4), at least two bending elements (4001) located on the arms (401), at least one rotary element (5) to which both bending elements (4001) are connected, at least one trigger (6) applying force to each bending element (4001), such that the material (M) is placed on the mandrel (3) by bending both of its edges simultaneously, wherein and enabling the material (M) to be held at least partially mutually, enabling the material (M) to be shaped on the mandrel (3), and enabling the bending elements (4001) to rotate there around, thereby enabling them to rotate around the rotary element (5), configured to form a part (P) by heat treatment of material (M) and multiple pulleys (7) being located on the body (2) in a stationary manner, thereby changing the direction of the force by making a rotational movement around their own direction, at least one elastic element (8), one end thereof being located on the bending elements (4001), the other end thereof being subjected to an applied force, passing over the pulleys (7) and enabling the force applied to the end thereof to be transferred to the bending elements (4001) by means of the pulleys (7), the pulleys (7) enabling the bending elements (4001) to rotate on the rotary element (5) by connecting the trigger (6) to the elastic element (8).

2. The forming table (1) according to claim 1, wherein an axis (A) throughout which the mandrel (3) extends longitudinally, the bending elements (4001) being located mirror-symmetrically with respect to the axis (A).

3. The forming table (1) according to claim 1, wherein the trigger (6) being as a weight, thereby applying a gravitational force to the bending elements (4001) and enabling one to make a clockwise rotational movement and the other one a counterclockwise rotational movement on the rotary element (5).

4. (canceled)

5. The forming table (1) according to claim 1, wherein at least two apparatuses (9) being located on the bending elements (4001) so as to be mirror-symmetrical with respect to the axis (A), said apparatuses being placed and fixed to a desired position on the bending elements (4001) by the user and the elastic element (8) being connected thereto, thereby enabling the moment on the rotary element (5) to be changed.

6. The forming table (1) according to claim 5, wherein at least two holes (10), one thereof being located on the apparatuses (9) and the other one on the bending elements (4001) so as to form mutual openings, and at least two pins (11), being inserted by a user into the mutual holes (10), thus enabling the apparatuses (9) to be fixed at user-desired positions on the bending elements (4001).

7. The forming table (1) according to claim 5, wherein a base (Z) on which the body (2) is located, multiple grooves (12) forming recess on the surface of the bending elements (4001) that is close to the base (Z), and at least one protrusion (13) extending outwardly over the apparatuses (9) and being provided in a form-fitting manner to the grooves (12), thereby preventing the horizontal movement of the apparatuses (9) on the bending elements (4001).

8. The forming table (1) according to claim 7, wherein the bending elements (4001) being mirror-symmetrical with respect to the axis (A) and having a distance in between them which is manufacturer-determined, at least one support arm (14) extending from the end of each bending element (4001) that is close to the axis (A) towards the base (Z), at least two first pulleys (701) being located between the support arms (14) and on the body (2) so as to be mirror-symmetrical with respect to the axis (A), at least two second pulleys (702) being located on the support arms (14), the trigger (6) enabling the bending elements (4001) to rotate on the rotary element (5) by being connected to the end of the elastic element (8) passing over the first pulleys (701) and the second pulleys (702).

9. The forming table (1) according to claim 1, wherein at least two support elements (15) being located on material (M) so as to be mirror-symmetrical with respect to the axis (A), thereby supporting the material (M) as it is given shape during the forming process.

10. The forming table (1) according to claim 5, wherein at least one channel (16) forming a throughout longitudinal opening on the bending elements (4001), the support elements (15) being located in connection with the apparatuses (9) so as to be movable along the channel (16), thereby making the distance between the apparatuses adjustable.

11. The forming table (1) according to claim 1, wherein at least one hanger (17) extending outwardly over the apparatuses (9), the elastic element (8) being able to move together with the support elements (15) with one end of the elastic element being located on the hanger (17) and the other end thereof on the second pulley (702).

12. The forming table (1) according to claim 10, wherein at least one holder (18) forming the frame (4), being located between the arms (401) and ensuring the continuity of the form of the material by holding the material (M) along at least one edge thereof, the position of the channel (16) between the arms (401) being adjustable by the user according to the size of the material (3) by holder being slidable within the channel.

13. The forming table (1) according to claim 12, wherein a first position (I) in which the arms (401) are located parallel to the base (Z), a second position (II) to which the arms (401) are brought by being bent and take almost the shape of the mandrel (3), and at least one rod (19) being located on the body (2), contacting the holder (18) when the arms (401) are bent and brought from the first position (I) to the second position (II), and taking almost the shape of the holder (18) that gives the edge shape to the part (P) and enabling it to be fixed.

14. The forming table (1) according to claim 1, wherein the a body (2) that enables shaping of the part (P), where the part (P) is a canopy.
